(19) United States
(12) Patent Application Publication
(10) Pub. No.: US 2024/0241094 A1
(43) Pub. Date: Jul. 18, 2024

(54) METHODS AND SYSTEMS FOR PERFORMING MASS SPECTROMETRY WITH A LOW SAMPLING RATE

(71) Applicant: Thermo Finnigan LLC, San Jose, CA (US)

(72) Inventors: Philip M. Remes, Livermore, CA (US); Scott T. Quarmby, Round Rock, TX (US)

(21) Appl. No.: 18/387,271

(22) Filed: Nov. 6, 2023

Related U.S. Application Data
(60) Provisional application No. 63/439,481, filed on Jan. 17, 2023.

(51) Int. Cl. G01N 30/86; B01D 15/08; G01N 30/14; G01N 30/72; G06N 20/00

(52) U.S. Cl. CPC G01N 30/8693; B01D 15/08; G01N 30/14; G01N 30/7233; G06N 20/00; G01N 2030/027

(57) ABSTRACT

A method of performing mass spectrometry includes obtaining, based on a series of mass spectra acquired over time with a first sampling rate as analytes elute from a separation system during an experiment, a first mass chromatogram dataset. The first mass chromatogram dataset represents a detected intensity of ions derived from the analytes and having a selected m/z as a function of time over a time period. The method further includes generating, based on the first mass chromatogram dataset and an upsampling model trained to upsample mass chromatogram data, a second mass chromatogram dataset representing an estimated intensity of the ions as a function of time over the time period. The second mass chromatogram dataset has a second sampling rate that is greater than the first sampling rate.

### RELATED APPLICATIONS

The present application claims priority under 35 U.S.C. § 119(e) to U.S. Provisional Patent Application No. 63/439,481, filed Jan. 17, 2023, which is incorporated herein by reference in its entirety.

### BACKGROUND INFORMATION

A mass spectrometer is a sensitive instrument that may be used to detect, identify, and/or quantify analytes based on the mass-to-charge ratio (m/z) of ions produced from the analytes. A mass spectrometer generally includes an ion source for producing ions from analytes included in a sample, a mass analyzer for separating the ions based on their m/z, and an ion detector for detecting the separated ions. The mass spectrometer may include or be connected to a computer-based software platform that uses data from the ion detector to construct a mass spectrum that shows a relative abundance of each of the detected ions as a function of m/z. The mass spectrum may be used to detect and quantify analytes in simple and complex mixtures.

A separation system, such as a liquid chromatograph (LC), gas chromatograph (GC), or capillary electrophoresis (CE) system, may be coupled to the mass spectrometer in a combined system (e.g., LC-MS, GC-MS, or CE-MS system) to separate, over time, analytes in the sample before the analytes are introduced to the mass spectrometer. In GC-MS or LC-MS experiments, analytes are differentially retained on the GC or LC column to reduce the ionization suppression and spectral complexity that would result if a complex sample were directly infused to the mass spectrometer. Thus, through the means of GC or LC, elution of analytes is spread out over time before introduction of the analytes to the mass spectrometer. The mass spectrometer acquires a series of mass spectra as the analytes elute from the separation system over time. The analytes have characteristic time profiles (elution peaks) that often roughly approximate a Gaussian shape. The identity of a particular analyte may be deduced from its pattern of spectral abundance and its retention time, and the quantity or concentration of the analyte may be deduced by integrating the area under its elution peak.

Sampling of the analytes' elution signal at frequencies above the Nyquist limit is considered a requirement of mass spectrometry methods, both to make certain that the integrated peak area is an accurate representation of the analyte concentration and to ensure the shape of the curve is characteristic of the pure analyte without interfering contaminants. The Nyquist limit is based on the Nyquist-Shannon sampling theory, which sets the minimum sampling rate for digital reconstruction of a signal as being a sampling rate that is two times the highest frequency in the signal. Sampling rates lower than the so-called Nyquist limit cause aliasing artifacts and render the data inaccurate or unusable. Often, a sampling rate somewhat higher than the Nyquist limit is chosen to sample a signal, such as 2.25 times the highest frequency, to avoid any uncertainty in the bandwidth of the actual signal. In GC-MS and LC-MS experiments, the Nyquist limit is sometimes expressed as a sampling rate requirement in terms of a number of points acquired across the elution peak.

For example, assuming the highest frequency of a signal is 0.1 Hz, the Nyquist limit would be 0.2 Hz, giving a sampling period of 5 seconds, which, depending on the elution peak width along the baseline, might result in a sampling rate requirement of about 7 points across a Gaussian-shaped elution peak. However, this sampling rate might be considered insufficient for many analytical scientists due to the expected variation in elution peak widths in a sample and the idea that many elution peaks exhibit non-Gaussian shapes, sometimes with steep leading edges. Thus, the sampling rate requirement for the experiment might be set higher, such as 8 or 10 points across the elution peak.

The sampling rate requirement limits the throughput of mass spectrometry experiments, particularly GC-MS and LC-MS experiments. In a targeted method, the throughput is determined by the distribution of target analyte elution times, the instrument scan speed, and the instrument sensitivity. As an illustrative example, consider an expected baseline peak width of 20 seconds and a sampling rate requirement of 10 samples across the elution peak, which yields a sampling period of 2000 milliseconds (ms). Given an instrument scan speed of 100 Hz (100 acquisitions per second, based on a 10 ms injection or dwell time per acquisition), the maximum number of target analytes that could be fully characterized with a targeted analysis during a sampling period at any given point in time is 200 (100 acquisitions per second over a 2000 ms sampling period).

In the case of data independent acquisition (DIA) experiments, the throughput limitation may be better termed as a data quality limitation through the isolation width parameter. In DIA experiments, the sampling rate requirement determines a smallest possible isolation width, which in practice will constrain the number of analytes that could be characterized at a given point in time. In the example above, 200 acquisitions per 2000 ms sampling period combined with a precursor m/z range of 400-1000 results in a DIA isolation width of 3 m/z per acquisition (1000 m/z-400 m/z divided by 200 acquisitions).

### SUMMARY

The following description presents a simplified summary of one or more aspects of the methods and systems described herein in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects of the methods and systems described herein in a simplified form as a prelude to the more detailed description that is presented below.

In some illustrative embodiments, a non-transitory computer-readable medium stores instructions that, when executed, direct at least one processor of a computing device for mass spectrometry to: obtain, based on a series of mass spectra acquired over time with a first sampling rate as analytes elute from a separation system during an experiment, a first mass chromatogram dataset representing a detected intensity of ions derived from the analytes and having a selected m/z as a function of time over a time period; and generate, based on the first mass chromatogram dataset and an upsampling model trained to upsample mass chromatogram data, a second mass chromatogram dataset representing an estimated intensity of the ions as a function of time over the time period, the second mass chromatogram dataset having a second sampling rate that is greater than the first sampling rate.

In some illustrative embodiments, a non-transitory computer-readable medium stores instructions that, when executed, direct at least one processor of a computing device for mass spectrometry to: obtain a series of mass spectra acquired over time by mass analyzing, with a first sampling rate, ions derived from analytes eluting from a separation system; generate, based on the series of mass spectra, training data comprising a plurality of training examples, each training example comprising a first mass chromatogram dataset for a selected m/z and a second mass chromatogram dataset for the selected m/z, wherein: the first mass chromatogram dataset includes a sequence of acquisition points over a time period and has a first sampling rate, and the second mass chromatogram dataset comprises a sequence of acquisition points over the time period and has a second sampling rate that is lower than the first sampling rate; and train, using the training data, a machine learning model to generate, based on the second mass chromatogram dataset, a third mass chromatogram dataset having the first sampling rate.

In some illustrative embodiments, a system for performing mass spectrometry comprises a memory storing instructions and a processor communicatively coupled to the memory and configured to execute the instructions to: obtain, based on a series of mass spectra acquired over time with a first sampling rate as analytes elute from a separation system during an experiment, a first mass chromatogram dataset representing a detected intensity of ions derived from the analytes and having a selected m/z as a function of time over a time period; and generate, based on the first mass chromatogram dataset and an upsampling model trained to upsample mass chromatogram data, a second mass chromatogram dataset representing an estimated intensity of the ions as a function of time over the time period, the second mass chromatogram dataset having a second sampling rate that is greater than the first sampling rate.

In some illustrative embodiments, a system comprises a memory storing instructions and a processor communicatively coupled to the memory and configured to execute the instructions to: obtain a series of mass spectra acquired over time by mass analyzing, with a first sampling rate, ions derived from analytes eluting from a separation system; generate, based on the series of mass spectra, training data comprising a plurality of training examples, each training example comprising a first mass chromatogram dataset for a selected m/z and a second mass chromatogram dataset for the selected m/z, wherein: the first mass chromatogram dataset includes a sequence of acquisition points over a time period and has a first sampling rate, and the second mass chromatogram dataset comprises a sequence of acquisition points over the time period and has a second sampling rate that is lower than the first sampling rate; and train, using the training data, a machine learning model to generate, based on the second mass chromatogram dataset, a third mass chromatogram dataset having the first sampling rate.

### BRIEF DESCRIPTION OF THE DRAWINGS

The accompanying drawings illustrate various embodiments and are a part of the specification. The illustrated embodiments are merely examples and do not limit the scope of the disclosure. Throughout the drawings, identical or similar reference numbers designate identical or similar elements.

FIG. 1 shows a functional diagram of an illustrative LC-MS system.

FIG. 2 shows a functional diagram of an illustrative implementation of the mass spectrometer of FIG. 1.

FIG. 3A shows a portion of an illustrative elution profile for a selected m/z.

FIG. 3B shows a frequency domain representation of the elution profile of FIG. 3A.

FIG. 4 shows a functional diagram of an illustrative mass spectrometry control system.

FIG. 5 shows an illustrative method of performing mass spectrometry using a low sampling rate.

FIG. 6 shows a graphical representation of a first mass chromatogram dataset for a selected m/z that may be obtained based on a series of mass spectra and that has a first sampling rate.

FIG. 7 shows a graphical representation of a second mass chromatogram dataset generated based on an upsampling model and the first mass chromatogram dataset of FIG. 6 and that has a second sampling rate that is greater than the first sampling rate of FIG. 6.

FIG. 8 shows a block diagram of an illustrative training stage in which a training module trains a machine learning model, using training data and an evaluation unit, to upsample a mass chromatogram dataset.

FIG. 9 shows an illustrative representation of a first mass chromatogram dataset having a first sampling rate (e.g., a high sampling rate) of a training example included in the training data of FIG. 8.

FIG. 10 shows an illustrative representation of a second mass chromatogram dataset having a second sampling rate (e.g., a low sampling rate) of the training example of FIG. 9.

FIG. 11 shows an illustrative method that may be performed to train the machine learning model of FIG. 8 to upsample mass chromatogram data.

FIG. 12 shows an illustrative method of training the machine learning model of FIG. 8 with a training example.

FIG. 13 shows an illustrative computing device.

### DETAILED DESCRIPTION

Herein described are methods, apparatuses, and systems for acquiring mass spectra with a low sampling rate (e.g., a sampling rate below the sampling rate requirement for the method and/or below the Nyquist limit) and converting (e.g., upsampling) the low sampling rate measurements into higher sampling rate representations through the use of a trained machine learning model. The low sampling rate techniques described herein may be used in MS, MS2, or MSn experiments, in targeted experiments in which a single target analyte is analyzed in each acquisition, and/or in multiplexed DIA experiments in which multiple targets within a specific isolation window are analyzed in each acquisition. As compared with traditional techniques, the low sampling rate techniques described herein allow increased throughput of mass spectrometry experiments, such as by reducing the time needed for MS analysis of target analytes, allowing more target analytes to be analyzed, and/or using smaller isolation widths in DIA experiments.

Various examples will now be described in more detail with reference to the figures. The systems and methods described herein may provide one or more of the benefits mentioned above and/or various additional and/or alternative benefits that will be made apparent herein.

In some implementations, the methods and systems described herein may be used in conjunction with a combined separation-mass spectrometry system, such as an LC-MS system. As such, an LC-MS system will now be described. The described LC-MS system is illustrative and not limiting. The methods and systems described herein may operate as part of or in conjunction with the LC-MS system described herein and/or with any other suitable separation-mass spectrometry system, including a high-performance liquid chromatography-mass spectrometry (HPLC-MS) system, a gas chromatography-mass spectrometry (GC-MS) system, a capillary electrophoresis-mass spectrometry (CE-MS) system, an ion mobility-mass spectrometry system (IMS-MS), or a liquid chromatography-ion mobility-mass spectrometry system (LC-IMS-MS). The methods and systems described herein may also operate in conjunction with any other continuous flow sample source, such as a flow-injection mass spectrometry system (FI-MS) in which analytes are injected into a mobile phase (without separation in a column) and enter the mass spectrometer with time-dependent variations in intensity (e.g., Gaussian-like elution peaks).

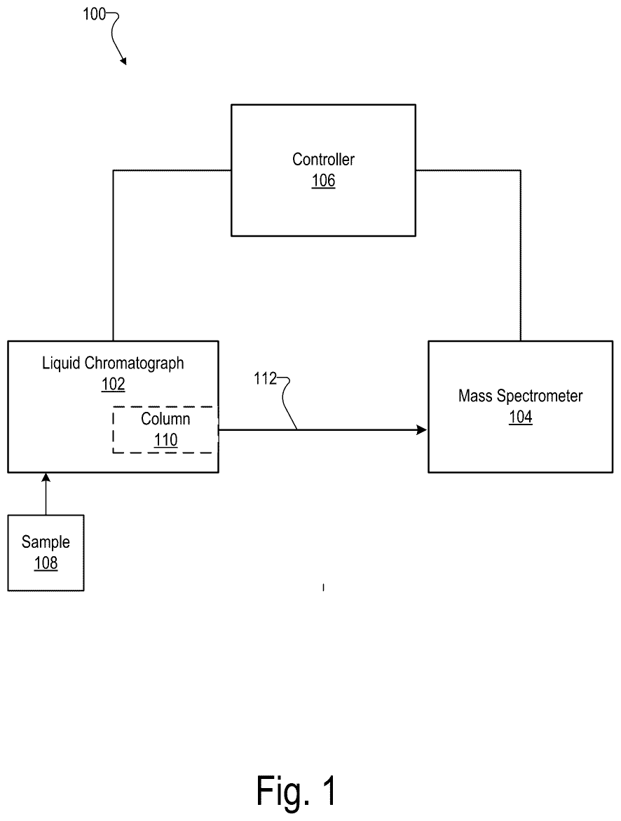

FIG. 1 shows a functional diagram of an illustrative LC-MS system 100. LC-MS system 100 includes a liquid chromatograph 102, a mass spectrometer 104, and a controller 106. Liquid chromatograph 102 is configured to separate, over time, components (e.g., analytes) within a sample 108 that is injected into liquid chromatograph 102. Sample 108 may include, for example, chemical components (e.g., molecules, ions, etc.) and/or biological components (e.g., metabolites, proteins, peptides, lipids, etc.) for detection and analysis by LC-MS system 100. Liquid chromatograph 102 may be implemented by any liquid chromatograph as may suit a particular implementation. In liquid chromatograph 102, sample 108 may be injected into a mobile phase (e.g., a solvent), which carries sample 108 through a column 110 containing a stationary phase (e.g., an adsorbent packing material). As the mobile phase passes through column 110, components within sample 108 elute from column 110 at different times based on, for example, their size, their affinity to the stationary phase, their polarity, and/or their hydrophobicity.

A detector (e.g., an ion detector component of mass spectrometer 104, an ion-electron converter and electron multiplier, etc.) may measure the relative intensity of a signal modulated by each separated component in eluate 112 from column 110. Data generated by the detector may be represented as a chromatogram, which plots retention time on the x-axis and a signal representative of the relative intensity on the y-axis. The retention time of a component is generally measured as the period of time between injection of sample 108 into the mobile phase and the relative intensity peak maximum after chromatographic separation. In some examples, the relative intensity may be correlated to or representative of relative abundance of the separated components. Data generated by liquid chromatograph 102 may be output to controller 106.

In some cases, particularly in analyses of complex mixtures, multiple different components in sample 108 co-elute from column 110 at approximately the same time, and thus may have the same or similar retention times. As a result, determination of the relative intensity of the individual components within sample 108 requires further separation of signals attributable to the individual components. To this end, liquid chromatograph 102 directs components included in eluate 112 to mass spectrometer 104 for identification and/or quantification of one or more of the components.

Mass spectrometer 104 is configured to produce ions from the components received from liquid chromatograph 102 and sort or separate the produced ions based on m/z of the ions. A detector in mass spectrometer 104 measures the intensity of the signal produced by the ions. As used herein, “intensity” or “signal intensity” refers to the response of the detector and may represent absolute abundance, relative abundance, ion count, intensity, relative intensity, ion current, or any other suitable measure of ion detection. Data generated by the detector may be represented as mass spectra, which plot the intensity of the observed signal as a function of m/z of the detected ions. Data acquired by mass spectrometer 104 may be output to controller 106.

Controller 106 may be communicatively coupled with, and configured to control operations of, LC-MS system 100 (e.g., liquid chromatograph 102 and mass spectrometer 104). Controller 106 may include any suitable hardware (e.g., a processor, circuitry, etc.) and/or software configured to control operations of and/or interface with the various components of LC-MS system 100 (e.g., liquid chromatograph 102 or mass spectrometer 104).

In some examples, mass spectrometer 104 is implemented by a multi-stage mass spectrometer configured to perform multi-stage mass spectrometry (denoted MSn where n is the number of stages (or generation of ions) and is an integer greater than or equal to two (2)). In multi-stage mass spectrometry, precursor ions produced from analytes are sorted (based on m/z) and fragmented, and the resulting product ions are mass analyzed. Multi-stage mass spectrometry performed using two stages (n=2) is often termed tandem mass spectrometry (MS2 or MS/MS). A multi-stage mass spectrometer may be multi-stage in space (e.g., different stages are performed in different mass analyzers) or multi-stage in time (e.g., different stages are performed at different times in the same mass analyzer).

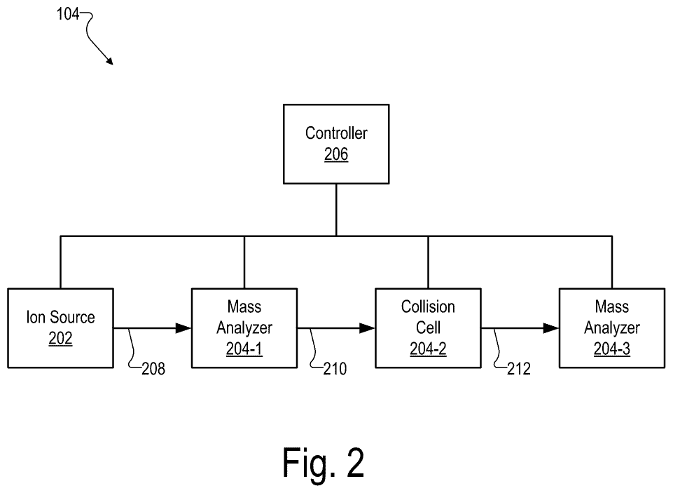

FIG. 2 shows a functional diagram of an illustrative implementation of mass spectrometer 104. As shown, mass spectrometer 104 is a multi-stage mass spectrometer that is tandem-in-space (e.g., has multiple mass analyzers) and has two stages for performing MS2. However, mass spectrometer 104 is not limited to this configuration but may have any other suitable configuration. For example, mass spectrometer 104 may be tandem-in-time and/or may have any other suitable number of stages.

Mass spectrometer 104 includes an ion source 202, a first mass analyzer 204-1, a collision cell 204-2, a second mass analyzer 204-3, and a controller 206. Mass spectrometer 104 may further include any additional or alternative components not shown as may suit a particular implementation (e.g., ion optics, filters, ion stores, an autosampler, a detector, etc.).

Ion source 202 is configured to produce ions 208 from the components and deliver ions 208 to first mass analyzer 204-1. Ion source 202 may use any suitable ionization technique, including without limitation electron ionization, chemical ionization, matrix assisted laser desorption/ionization, electrospray ionization, atmospheric pressure chemical ionization, atmospheric pressure photoionization, inductively coupled plasma, and the like. Ion source 202 may include various components for producing ions 208 from components included in sample 108 and delivering ions 208 to first mass analyzer 204-1.

First mass analyzer 204-1 is configured to receive ions 208, isolate precursor ions of a selected m/z range and deliver precursor ions 210 to collision cell 204-2. Collision cell 204-2 is configured to receive precursor ions 210 and produce product ions 212 (e.g., fragment ions) via controlled dissociation processes. Collision cell 204-2 is further configured to direct product ions 212 to second mass analyzer 204-3. Second mass analyzer 204-3 is configured to filter and/or perform a mass analysis of product ions 212.

Mass analyzers 204-1 and 204-3 are configured to isolate or separate ions according to m/z of each of the ions. Mass analyzers 204-1 and 204-3 may be implemented by any suitable mass analyzer, such as a quadrupole mass filter, an ion trap (e.g., a three-dimensional quadrupole ion trap, a cylindrical ion trap, a linear quadrupole ion trap, a toroidal ion trap, etc.), a time-of-flight (TOF) mass analyzer, an electrostatic trap mass analyzer (e.g. an orbital electrostatic trap such as an Orbitrap mass analyzer, a Kingdon trap, etc.), a Fourier transform ion cyclotron resonance (FT-ICR) mass analyzer, and the like. Mass analyzers 204-1 and 204-3 may be the same type of mass analyzer or may be different types of mass analyzers.

Collision cell 204-2 may be implemented by any suitable collision cell. As used herein, “collision cell” may encompass any structure or device configured to produce product ions via controlled dissociation processes and is not limited to devices employed for collisionally-activated dissociation. For example, collision cell 204-2 may be configured to fragment precursor ions using collision induced dissociation, electron transfer dissociation, electron capture dissociation, photo induced dissociation, surface induced dissociation, ion/molecule reactions, and the like.

An ion detector (not shown) is configured to detect ions at each of a variety of different m/z and responsively generate an electrical signal representative of ion intensity. The electrical signal is transmitted to controller 206 for processing, such as to construct a mass spectrum of the sample. For example, mass analyzer 204-3 may emit an emission beam of separated ions to the ion detector, which is configured to detect the ions in the emission beam and generate or provide data that can be used by controller 206 to construct a mass spectrum of the sample. The ion detector may be implemented by any suitable detection device, including without limitation an electron multiplier, a Faraday cup, and the like.

Controller 206 may be communicatively coupled with, and configured to control operations of, mass spectrometer 104. For example, controller 206 may be configured to control operation of various hardware components included in ion source 202 and/or mass analyzers 204-1 and 204-3. To illustrate, controller 206 may be configured to control an accumulation time of ion source 202 and/or mass analyzers 204, control an oscillatory voltage power supply and/or a DC power supply to supply an RF voltage and/or a DC voltage to mass analyzers 204, adjust values of the RF voltage and DC voltage to select an effective m/z (including a mass tolerance window) for analysis, and adjust the sensitivity of the ion detector (e.g., by adjusting the detector gain).

Controller 206 may also include and/or provide a user interface configured to enable interaction between a user of mass spectrometer 104 and controller 206. The user may interact with controller 206 via the user interface by tactile, visual, auditory, and/or other sensory type communication. For example, the user interface may include a display device (e.g., liquid crystal display (LCD) display screen, a touch screen, etc.) for displaying information (e.g., mass spectra, notifications, etc.) to the user. The user interface may also include an input device (e.g., a keyboard, a mouse, a touchscreen device, etc.) that allows the user to provide input to controller 206. In other examples the display device and/or input device may be separate from, but communicatively coupled to, controller 206. For instance, the display device and the input device may be included in a computer (e.g., a desktop computer, a laptop computer, etc.) communicatively connected to controller 206 by way of a wired connection (e.g., by one or more cables) and/or a wireless connection.

Controller 206 may include any suitable hardware (e.g., a processor, circuitry, etc.) and/or software as may serve a particular implementation. While FIG. 2 shows that controller 206 is included in mass spectrometer 104, controller 206 may alternatively be implemented in whole or in part separately from mass spectrometer 104, such as by a computing device communicatively coupled to mass spectrometer 104 by way of a wired connection (e.g., a cable) and/or a network (e.g., a local area network, a wireless network (e.g., Wi-Fi), a wide area network, the Internet, a cellular data network, etc.). In some examples, controller 206 may be implemented in whole or in part by controller 106.

Referring again to FIG. 1, controller 106 may be communicatively coupled with, and configured to control operations of, LC-MS system 100 (e.g., liquid chromatograph 102 and/or mass spectrometer 104). Controller 106 may include any suitable hardware (e.g., a processor, circuitry, etc.) and/or software configured to control operations of and/or interface with the various components of LC-MS system 100 (e.g., liquid chromatography 102 and/or mass spectrometer 104).

For example, controller 106 may be configured to acquire data acquired over time by LC-MS system 100. The data may include a series of mass spectra including intensity values of ions produced from the components of sample 108 as a function of m/z of the ions. The series of mass spectra may be represented in a three-dimensional map in which time (e.g., retention time) is plotted along an x-axis, m/z is plotted along a y-axis, and intensity is plotted along a z-axis. Spectral features on the map (e.g., z-axis peaks of intensity) represent detection by LC-MS system 100 of ions produced from various analytes included in sample 108. The x-axis and z-axis of the map may be used to generate an elution profile (e.g., a mass chromatogram) that plots detected intensity as a function of elution time (e.g., retention time) for a selected m/z.

As used herein, a “selected m/z” may be a specific m/z with or without a mass tolerance window (e.g., +/−0.5 m/z), or may be a narrow range of m/z (e.g., an isolation window such as 20 m/z, 10 m/z, 4 m/z, 3 m/z, etc.). In a single-stage mass spectrometry (MS) analysis, such as a full MS scan or selected ion monitoring (SIM) analysis, the selected m/z corresponds to the m/z or m/z range of the MS acquisition. In a multi-stage wide scan experiment, such as a full MS2 scan or a full MSn scan, the selected m/z corresponds to the wide m/z range (e.g., full m/z range) used to scan product ions. In a targeted MS2 or MSn analysis, such as a selected reaction monitoring (SRM) analysis, a multiple reaction monitoring (MRM) analysis, or a parallel reaction monitoring (PRM) analysis, the selected m/z corresponds to the m/z of the product ion of a distinct transition (precursor ion/product ion pair), and the recorded intensity as a function of time vector (e.g., trace) represents the elution profile for the distinct transition. In a DIA analysis, the recorded intensity as a function of time vector is an extracted product ion chromatogram for the selected m/z of the product ion. The y-axis and z-axis of the map may be used to generate mass spectra, each mass spectrum plotting intensity as a function of m/z for a particular acquisition.

As mentioned, the quantity of an analyte may be determined by integrating the area under its elution peak. In some examples, quantification of the analyte includes summing the detected signal for multiple different selected m/z for product ions that are characteristic of the analyte of interest and integrating the area under the summed signal. For example, an analyte of interest may have multiple characteristic transitions, each of which may be summed to form an elution profile with an increased signal to noise ratio. As used herein, “selected m/z” may also be a combination of multiple distinct m/z or m/z ranges. For example, the selected m/z for an analyte of interest may be the combination of multiple distinct m/z or m/z ranges for each ion characteristic of the analyte of interest, and the elution profile for the selected m/z may be the summed signal of each distinct m/z or m/z range. In further examples, the multiple distinct m/z or m/z ranges span the full m/z spectrum, wherein the elution profile is a total ion current (TIC).

As used herein, an “acquisition” refers to a mass analysis performed at a point in time to acquire a single mass spectrum across an m/z range of interest. It will be recognized that, in some targeted MS2 analyses, true “spectra” are not acquired in that the detected intensity as a function of time is acquired or recorded for only a selected m/z and not for a broad m/z spectrum. Nevertheless, for ease of discussion herein, the recorded intensity/time vector for such targeted MS2 analyses is referred to herein as a mass spectrum.

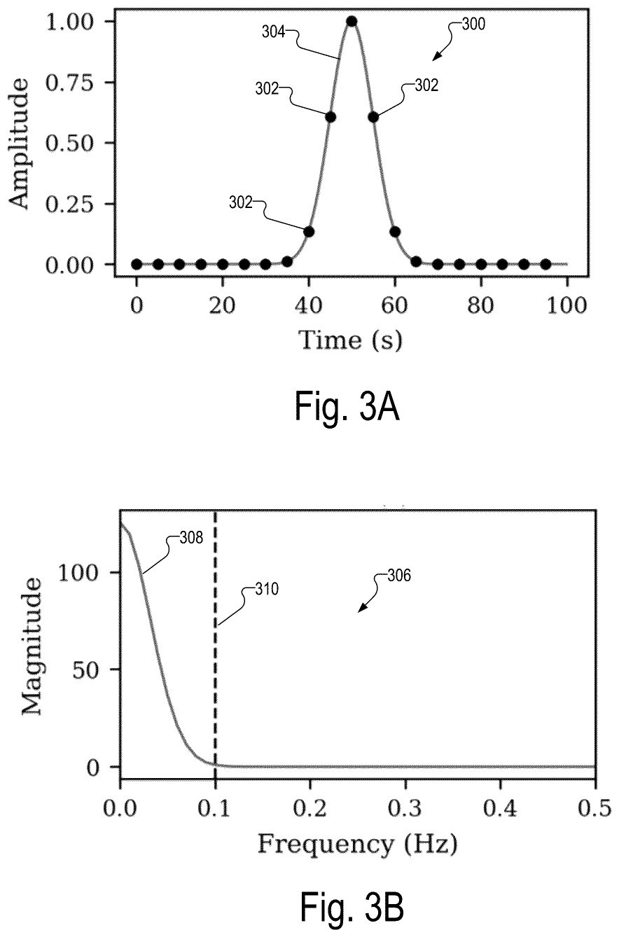

The sampling rate of an elution profile will now be described with reference to FIGS. 3A and 3B. FIG. 3A shows a portion of an illustrative elution profile 300 (indicated by the solid line curve) of a selected m/z. Elution profile 300 is generated from data acquired by the mass spectrometer, such as a plurality of MS2 acquisitions. Elution profile 300 plots intensity (arbitrary units) as a function of elution time. For chromatographic separation applications, elution time refers to retention time, which is generally measured as the period of time between injection of the sample into the mobile phase and the relative intensity peak maximum after chromatographic separation. For capillary electrophoresis applications, in which analytes are not retained but instead continuously migrate, elution time refers to migration time. Migration time is generally measured as the period of time taken for an analyte to migrate from the beginning of the capillary to a detection location. For ion mobility separations, elution time refers to drift time of the analyte through a buffer gas, which may take place either in-space (e.g. a drift tube) or in-time (e.g. a trapped ion mobility cell).

As shown in FIG. 3A, elution profile 300 includes a plurality of acquisition points 302, each obtained by a different acquisition. As analytes elute, the detected intensity of ions produced from the analytes form an elution peak 304 having a roughly Gaussian profile. However, elution peak 304 and/or other elution peaks (not shown) in elution profile 300 may have other, non-Gaussian profiles.

As used herein, “sampling rate” is the number of acquisitions per unit of time for a selected m/z. In the example of FIG. 3A, the sampling rate is approximately 0.2 Hz (4 acquisitions every 20 seconds). The sampling rate may also be expressed as the number of acquisitions per elution peak. An elution peak may be defined as any detected signal above a threshold value (e.g., 5% or 10% above a baseline signal). In FIG. 3A, elution peak 304 spans a period of about 30 seconds (e.g., from 35 seconds to 65 seconds). Thus, the sampling rate of FIG. 3A may be expressed as six acquisitions per peak.

As used herein, “sampling period” is the duration of time between sequential acquisitions (e.g., between sequential acquisition points 302) in the elution profile of a selected m/z. In the example of FIG. 3A, the sampling period is approximately 5 seconds. During the sampling period, a mass analysis is performed for each of multiple different selected m/z, generally each with the same sampling rate. Accordingly, multiple acquisitions are performed, each for a different selected m/z, during a sampling period, and the sampling cycle is repeated multiple times to generate an elution profile for each distinct selected m/z.

As used herein, “instrument speed” or “acquisition rate” refers to the time taken by the mass spectrometer to perform an acquisition. The instrument speed is generally based on characteristics and parameters of the mass spectrometer, such as mass analysis time and ion injection time and/or dwell time. The instrument speed and the sampling period determine the number of target analytes (distinct selected m/z) that may be analyzed during a sampling period and, hence, during an experiment.

Many experiments have a sampling rate requirement. As used herein, “sampling rate requirement” refers to the minimum number of acquisitions per unit of time for each selected m/z or to the minimum number of acquisitions across each elution peak, as required by method parameters for a particular experiment being performed. The sampling rate requirement may be informed by, but is not necessarily the same as, the Nyquist limit. The Nyquist limit may be determined based on a frequency domain representation of the elution profile of the selected m/z. FIG. 3B shows a frequency domain representation 306 of elution profile 300. FIG. 3B may be generated from elution profile 300 in any suitable way, such as by performing a Fourier transform on elution profile 300. Frequency domain representation 306 includes a peak 308 corresponding to elution peak 304. Based on peak 308, one may determine that the highest frequency to digitally recover is 0.1 Hz, as indicated by dashed line 310. Accordingly, the Nyquist limit would be 0.2 Hz (e.g., twice the highest frequency), giving a sampling period of 5 seconds and a sampling rate of 6 acquisitions across elution peak 304. A sampling rate that matches or exceeds the Nyquist limit is presumed to generate data with sufficient precision to accurately determine peak intensity and peak area.

However, as can be seen from FIG. 3B, the Nyquist limit could vary depending on the highest frequency cutoff that is chosen. A different highest frequency value might be chosen depending on experimental conditions, objectives, and tolerance for artifacts. For example, one might select the highest frequency cutoff at 0.09 Hz or some other value less than 0.1 Hz. Moreover, the Nyquist limit is not easily defined for a non-sinusoidal peak waveform, such as the Gaussian peak waveform of elution profile 300. Non-Gaussian elution peak waveforms might require more acquisitions than even the Nyquist limit might indicate. Accordingly, some experiments and developed methods have a sampling rate requirement that is higher than what the Nyquist limit might indicate. For example, a sampling rate requirement for an experiment might be four times the highest frequency, or a sampling period of 2.5 seconds in the example of FIGS. 3A and 3B. Due to the possible variations in the Nyquist limit, the sampling rate requirement for an experiment may be expressed as the minimum number of acquisitions per unit of time for a selected m/z and/or as the minimum number of acquisitions across each elution peak.

For most experiments, the sampling rate requirement is at least six acquisitions per elution peak, and in many experiments is a value between six and fifteen acquisitions per elution peak. In some examples, such as for Gaussian-shaped elution profiles, the sampling rate requirement is five acquisitions per peak. In other examples, the sampling rate requirement is six acquisitions per peak. In further examples, the sampling rate requirement is eight acquisitions per peak. In yet further examples, the sampling rate requirement is ten acquisitions per peak. As explained above, the sampling rate may also be expressed as acquisitions per unit time. Accordingly, in some examples, the sampling rate requirement is 0.25 Hz or higher. In further examples, the sampling rate requirement is 0.30 Hz or higher. In yet further examples, the sampling rate requirement is 0.40 Hz or higher. In even further examples, the sampling rate requirement is 0.50 Hz or higher.

As used herein, a “low sampling rate” for a particular experiment means a sampling rate that is less than the sampling rate requirement for the experiment. As used herein, a “high sampling rate” for a particular experiment means a sampling rate that is equal to or greater than the sampling rate requirement for the experiment. To illustrate, if the sampling rate requirement for an experiment is six acquisitions per peak, a sampling rate less than six acquisitions per peak (e.g., two to five acquisitions per peak) is a low sampling rate and six or more acquisitions per peak is a high sampling rate.

As explained above, the sampling rate requirement limits the throughput for a targeted experiment and/or limits the data quality for a DIA experiment. The methods, systems, and apparatuses described herein address these problems by acquiring mass spectra using a low sampling rate and converting (e.g., upsampling) the low sampling rate measurements into high sampling rate representations through the use of a trained machine learning model.

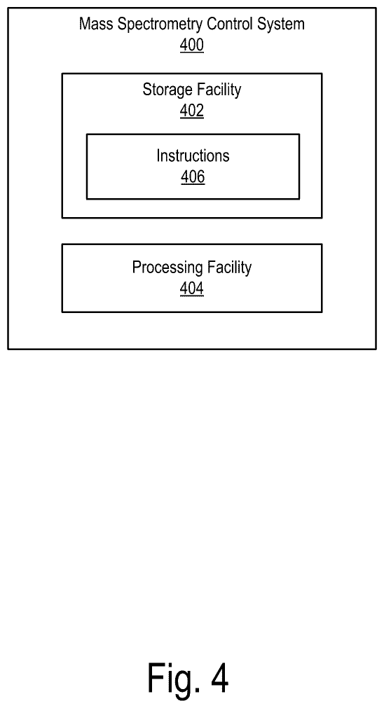

One or more operations associated with acquiring mass spectra using a low sampling rate and converting the low sampling rate measurements into high sampling rate representations may be performed by a mass spectrometry control system. FIG. 4 shows an illustrative mass spectrometry control system 400 (“system 400”). System 400 may be implemented entirely or in part by a combined separation-mass spectrometry system (e.g., by controller 106 and/or controller 206 of LC-MS system 100). Alternatively, system 400 may be implemented separately from a combined separation-mass spectrometry system (e.g., a remote computing system or server).

System 400 may include, without limitation, a storage facility 402 and a processing facility 404 selectively and communicatively coupled to one another. Facilities 402 and 404 may each include or be implemented by hardware and/or software components (e.g., processors, memories, communication interfaces, instructions stored in memory for execution by the processors, etc.). In some examples, facilities 402 and 404 may be distributed between multiple devices and/or multiple locations as may serve a particular implementation.

Storage facility 402 may maintain (e.g., store) executable data used by processing facility 404 to perform any of the operations described herein. For example, storage facility 402 may store instructions 406 that may be executed by processing facility 404 to perform any of the operations described herein. Instructions 406 may be implemented by any suitable application, software, code, and/or other executable data instance.

Storage facility 402 may also maintain any data acquired, received, generated, managed, used, and/or transmitted by processing facility 404. For example, storage facility 402 may maintain LC-MS data (e.g., acquired chromatogram data and/or mass spectra data) and/or model data. Model data may include data representative of, used by, or associated with one or more models (e.g., machine learning models) and/or algorithms maintained by processing facility 404 for upsampling mass chromatogram data (e.g., converting low sampling rate data into high sampling rate data).

Processing facility 404 may be configured to perform (e.g., execute instructions 406 stored in storage facility 402 to perform) various processing operations described herein. It will be recognized that the operations and examples described herein are merely illustrative of the many different types of operations that may be performed by processing facility 404. In the description herein, any references to operations performed by system 400 may be understood to be performed by processing facility 404 of system 400. Furthermore, in the description herein, any operations performed by system 400 may be understood to include system 400 directing or instructing another system or device to perform the operations.

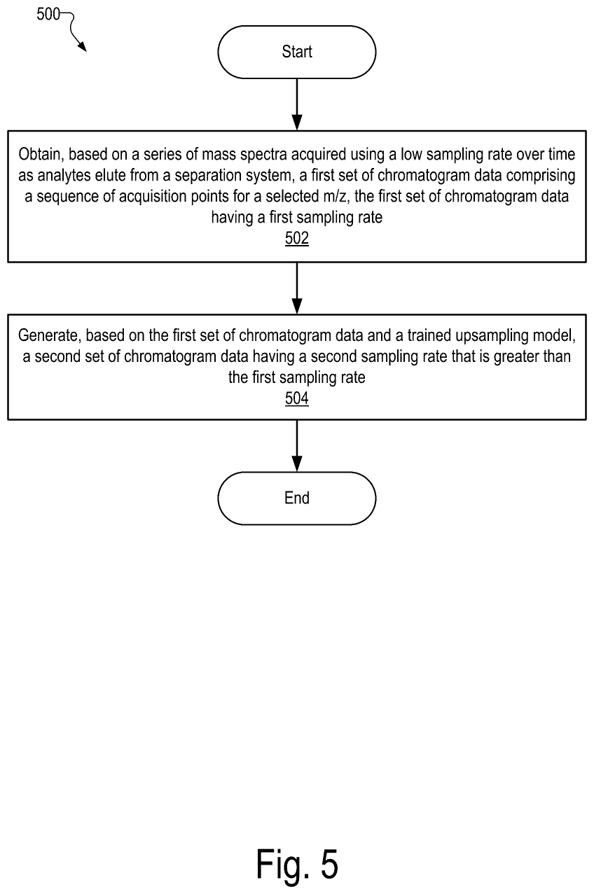

FIG. 5 shows an illustrative method 500 of performing mass spectrometry. While FIG. 5 shows illustrative operations according to one embodiment, other embodiments may omit, add to, reorder, and/or modify any of the operations shown in FIG. 5.

In operation 502, system 400 obtains, based on a series of mass spectra acquired over time with a low sampling rate as analytes elute from a separation system, a first mass chromatogram dataset for a selected m/z. The first mass chromatogram dataset has a first sampling rate. In some examples, the first sampling rate is a low sampling rate (e.g., a sampling rate less than a sampling rate requirement for the experiment). The series of mass spectra may be acquired in any suitable way.

In some examples, such as in a GC-MS experiment, the series of mass spectra are acquired by performing single-stage MS, such as a full MS analysis or SIM analysis. In other examples, the series of mass spectra are acquired by performing multi-stage analyses, such as wide or full MS2 or MSn scans of product ions.

In further examples, the series of mass spectra are acquired by performing a targeted analysis of one or more target analytes eluting from a separation system. Targeted mass spectrometry has many variations, such as selected reaction monitoring (SRM), multiple reaction monitoring (MRM), and parallel reaction monitoring (PRM). In a targeted experiment, MS2 (or MSn) analysis of each analyte is scheduled to be performed during a narrow window of time around the characteristic elution time of each target analyte. At the characteristic elution time of a target analyte, precursor ions derived from the target analyte are selected in a first stage and fragmented into product ions, and the resulting product ions are mass analyzed in a second stage. A series of MS2 (or MSn) acquisitions may be performed to record the detected intensity as a function of elution time of product ions derived from each target analyte. In this targeted approach, the first mass chromatogram dataset obtained from the series of mass spectra includes the set of acquisition points that form at least a part of the elution profile for a selected m/z. The selected m/z is the m/z corresponding to the product ion of a particular transition.

In other examples, the series of mass spectra are acquired by performing DIA analyses of analytes eluting from the separation system. In a DIA analysis, all precursor ion species within a wide precursor m/z range (e.g., 500-1000 m/z) are isolated and fragmented via an isolation window of an isolation width (e.g., 20 m/z) successively positioned through the precursor m/z range to generate product ions. An MS2 (or MSn) analysis is performed on the product ions in a methodical and unbiased manner. The acquisition of mass spectra spanning the full precursor m/z range constitutes one DIA cycle and is performed over a sampling period. The DIA cycle is repeated over time as the analytes elute, thereby producing a series of mass spectra. In the DIA approach, the first mass chromatogram dataset obtained from the series of mass spectra comprises the set of acquisition points that form at least a part of the elution profile (e.g., an extracted product ion chromatogram) for the selected m/z.

In an MS analysis, MS2 or MSn full scan analysis, targeted analysis, or DIA analysis, the series of mass spectra are acquired using the first sampling rate or another sampling rate. In some examples, the series of mass spectra are acquired using a low sampling rate. The series of mass spectra include a set of acquisition points for each selected m/z, wherein each acquisition point is based on a different acquisition and represents a detected intensity of product ions as a function of elution time for the selected m/z. The acquisition points for the selected m/z, together, form an elution profile for the selected m/z.

The first mass chromatogram dataset is based on the set of acquisition points obtained from the series of mass spectra and includes a set of acquisition points that together form an elution profile for the selected m/z over a time period that includes an elution peak. The sequence of acquisition points spans the elution peak for the selected m/z and may include any number of acquisition points (e.g., 5, 6, 8, 10, 12, 15, 16, 32, 50, 64, 100, 128, etc.). As will be explained below, in some examples the number of acquisition points in the first mass chromatogram dataset is based on the number of acquisition points to be input to a trained upsampling model.

As mentioned, the first mass chromatogram dataset has a first sampling rate. In some examples, the first sampling rate is a low sampling rate (e.g., less than a sampling rate requirement for the experiment). For example, method parameters for the experiment may indicate a sampling rate requirement of eight acquisitions across each elution peak. Accordingly, the first sampling rate is less than eight acquisitions per peak (e.g., any number ranging from two to five, six, or seven, inclusive). In some examples, the first sampling rate is a fraction of the sampling rate requirement (e.g., one-half (½), three-fourths (¾), two-thirds (⅔), etc.). In GC-MS experiments, the characteristic peak width is generally small and typically ranges from about 1 to about 2 seconds. Accordingly, a sampling rate requirement of 6 acquisitions per peak for GC-MS might correspond to a sampling frequency of about 3-6 Hz. A low sampling rate for such GC-MS experiment would be less than 6 acquisitions per peak (e.g., 3, 4 or 5).

In some examples, such as when the series of mass spectra is acquired using a sampling rate that is different than the first sampling rate or when the sampling period of the original series of mass spectra is not uniform (e.g., due to instrument or experiment variations), the first mass chromatogram dataset is generated by obtaining and adjusting a subset of the original acquisition points of the series of mass spectra to a uniform sampling period (e.g., two seconds, three seconds, etc.), such as by interpolation, so that the first mass chromatogram dataset has the first sampling rate. Such adjustment to a uniform sampling period simplifies processing by the upsampling model. To illustrate, a subset of acquisition points extracted from the series of mass spectra may have a sampling period ranging between 2.9 and 3.2 seconds. These original acquisition points may be adjusted by interpolation to generate a sequence of acquisition points having a uniform 3.0 second sampling period.

In some examples, the first mass chromatogram dataset is further generated by normalizing the sequence of acquisition points of the first mass chromatogram dataset to a reference intensity value. Any normalization scheme and reference intensity value may be used, such as a known running average intensity value of the elution profile, a global maximum intensity value of the elution profile, a recent maximum intensity value, etc. Normalization of the intensity value of the sequence of acquisition points of the first mass chromatogram dataset simplifies processing by the upsampling model. However, this normalization step is optional and may be omitted.

In operation 504, system 400 generates, based on the first mass chromatogram dataset and a trained upsampling model configured to upsample mass chromatogram data, a second mass chromatogram dataset having a second sampling rate that is greater than the first sampling rate. The second mass chromatogram dataset includes a sequence of acquisition points that represent an estimated intensity of the ions as a function of time over the same time period as the first mass chromatogram dataset. In some examples, the second sampling rate is a high sampling rate (e.g., equal to or greater than the sampling rate requirement for the experiment).

System 400 generates the second mass chromatogram dataset by applying the upsampling model to the first mass chromatogram dataset (e.g., inputs the first mass chromatogram dataset to the upsampling model). The upsampling model is configured to use the first mass chromatogram dataset as an input vector to perform any suitable heuristic, process, and/or operation that may be performed or executed by system 400 to generate the second mass chromatogram dataset. In some examples, the upsampling model is implemented by hardware and/or software components (e.g., processors, memories, communication interfaces, instructions stored in memory for execution by the processors, etc.), such as storage facility 402 and/or processing facility 404 of system 400. The upsampling model may include any suitable algorithm and/or machine learning model configured to upsample mass chromatogram data (e.g., convert low sampling rate mass chromatogram data to high sampling rate mass chromatogram data). In some examples, the upsampling model is a trained machine learning model, such as a trained neural network (e.g., a convolutional neural network (CNN) such as an autoencoder-decoder network, a denoising autoencoder, etc.). An illustrative trained machine learning model, and methods of training the machine learning model, will be described below in more detail.

In some examples, the upsampling model has been trained, at the time of execution of method 500, based on training data acquired during multiple different experiments performed under different sets of experiment conditions. As a result, the upsampling model may be used across a wide range of experiment conditions. A set of experiment conditions may specify, for example, one or more of a flow rate of the separation system (e.g., nanoflow, microflow, high flow), a gradient of the chromatography column, a list of target analytes, and/or the type of chromatography (e.g., capillary electrophoresis, liquid chromatography, gas chromatography, etc.), the type of stationary and/or mobile phase (e.g., hydrophilic interaction chromatography (HILIC), ion chromatography, C18 particles, C8 particles, etc.). In other examples, the upsampling model has been trained based on training data configured for a specific application, such as specific experiment conditions, a specific sample type, a specific list of target analytes, etc. In some examples, system 400 selects, based on a set of experiment conditions for analyzing sample 108, the upsampling model from among a plurality of trained machine learning models each trained for a particular application.

Method 500 may be performed for a plurality of analytes included in the sample. For example, method 500 may be performed to generate a second mass chromatogram for each selected m/z that is processed. The second mass chromatogram datasets generated at operation 504 may be output and used in any suitable way, such as to analyze and characterize the sample. For example, the second mass chromatogram datasets may be used to identify analytes based on their patterns of spectral abundance. The second mass chromatograms may additionally or alternatively be used to quantify analytes by integrating the area under the elution peaks. By using method 500, mass spectra may be acquired using a low sampling rate and the resulting data may be upsampled while maintaining fidelity to the quality of data that would be acquired with a high sampling rate. Using the first sampling rate (e.g., a low sampling rate) allows an increased throughput for the experiment as compared with using the second sampling rate (e.g., a high sampling rate).

In some examples, method 500 may be performed in real-time as the experiment progresses. For example, the second mass chromatogram may be used to detect when an intensity value of an elution peak exceeds a threshold level, which may be used, for example, in a data-dependent acquisition (DDA) method.

In some modifications of method 500, system 400 may determine and set the sampling rate for acquiring the series of mass spectra. System 400 may determine the sampling rate in any suitable way. In some examples, system 400 may determine an average or expected baseline peak width for the experiment (e.g., based on a set of target analytes) and set the sampling rate to be a predetermined sampling rate, such as three, four, or five acquisition points per elution peak. To illustrate, system 400 may determine that an average peak width at the baseline is 20 seconds. Accordingly, system 400 may set the sampling rate to be four acquisitions per peak, or 0.2 Hz (5 second sampling period).

In some examples, system 400 determines a sampling rate requirement for the experiment and sets a low sampling rate for the acquiring the series of mass spectra based on the determined sampling rate requirement. System 400 may determine the sampling rate requirement for the experiment in any suitable way, such as based on user input indicating the sampling rate requirement and/or based on information about the experiment to be performed (e.g., instrument parameters, a list of target analytes, etc.). System 400 may set the sampling rate for acquisition of the series of mass spectra as a predetermined fraction of the sampling rate requirement (e.g., one-half (½), one-third (⅓), three-fourths (¾), etc.). Alternatively, system 400 may set the sampling rate to be any sampling rate that is less than the sampling rate requirement.

In some experiments, the shape and/or width of elution peaks for analytes in the sample may vary over time. Accordingly, system 400 may acquire the series of mass spectra with a different sampling rate at different times during the experiment. For example, elution peaks may have a more Gaussian shape at the start of the experiment, and toward the end of the experiment may have longer tails. The sampling rate requirement may change (e.g., decrease) for wider peaks, and so system 400 may also decrease the sampling rate used to acquire the mass spectra toward the end of the experiment.

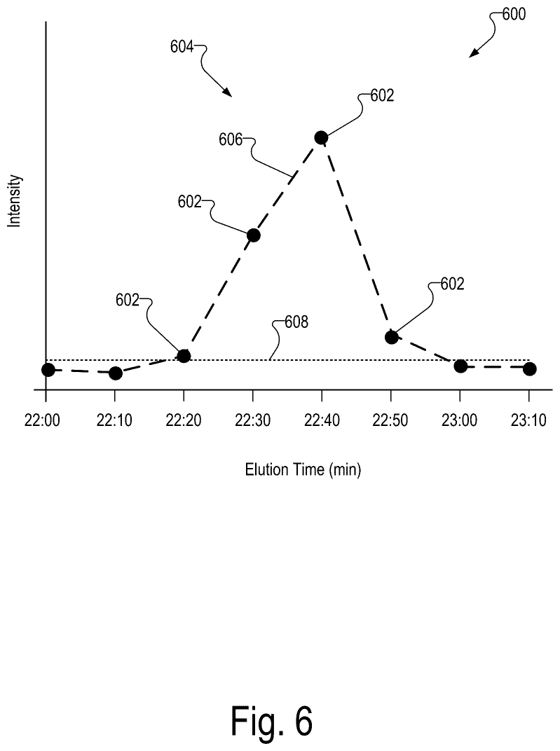

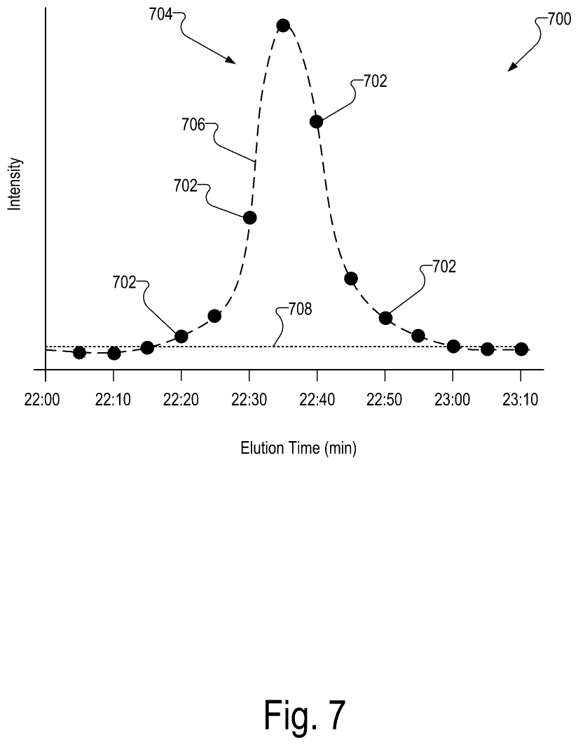

An illustrative processing of method 500 will now be described with reference to FIGS. 6 and 7. FIG. 6 shows a graphical representation 600 of a first mass chromatogram dataset for a selected m/z that may be obtained from a series of mass spectra. As shown, the first mass chromatogram dataset includes a sequence of eight acquisition points 602 spanning a time period of 70 seconds. As shown, acquisition points 602 have a sampling period of ten seconds. An elution profile 604 for the selected m/z is represented by a dashed line curve and includes a peak 606 comprising acquisition points above a threshold intensity level 608 (e.g., 5% above a baseline signal). As shown by elution profile 604, the first mass chromatogram dataset has a sampling period of ten seconds and a first sampling rate of four acquisition points 602 across peak 606 (e.g., 0.10 Hz), which spans 40 seconds. If the sampling rate requirement is six acquisitions per peak or greater (e.g., 0.15 Hz or greater), the first sampling rate is a low sampling rate. It will be recognized that the first mass chromatogram dataset may have any other suitable number of acquisition points (e.g., 10, 12, 15, 24, 32, etc.) and may span any other suitable time period (e.g., 0.5 seconds, 1 second, 2 seconds, 5 seconds, 30 seconds, 60 seconds, 90 seconds, 2 minutes, etc.).

The first mass chromatogram dataset is applied as an input vector to an upsampling model configured to upsample the first mass chromatogram dataset. The upsampling model generates, based on the first mass chromatogram dataset, a second mass chromatogram dataset having a high sampling rate. FIG. 7 shows a graphical representation 700 of the second mass chromatogram dataset generated based on the upsampling model and the first mass chromatogram dataset. As shown, the second mass chromatogram dataset includes a set of fourteen acquisition points 702 spanning the same time period as the first mass chromatogram dataset (shown in FIG. 6). Acquisition points 702 together form an elution profile 704 (represented by the dashed line curve) having a peak 706 comprising acquisition points above a threshold intensity level 708. The second mass chromatogram dataset has a sampling period of five seconds and a second sampling rate of ten acquisition points 702 across peak 706 (or 0.25 Hz). Thus, the second mass chromatogram dataset has a high sampling rate (e.g., the sampling rate is greater than the sampling rate requirement of six acquisitions per peak, or 0.15 Hz).

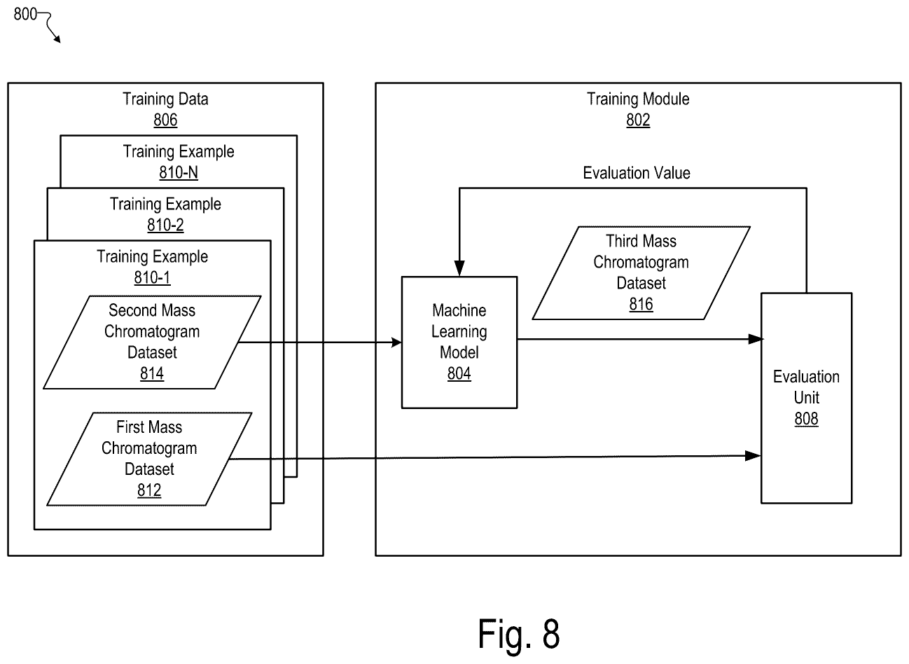

Generation and training of an upsampling model will now be described with reference to FIGS. 8-13. FIG. 8 shows a block diagram of an illustrative training stage 800 in which a training module 802 trains a machine learning model 804, using training data 806 and an evaluation unit 808, to upsample a mass chromatogram dataset. When trained as described herein, machine learning model 804 may implement the upsampling model used in operation 504 of method 500.

Training module 802 may perform any suitable heuristic, process, and/or operation that may be configured to train machine learning model 804. In some examples, training module 802 is implemented by hardware and/or software components (e.g., processors, memories, communication interfaces, instructions stored in memory for execution by the processors, etc.). In some examples, training module 802 is implemented by system 400, or any component or implementation thereof. For example, training module 802 may be implemented by a controller of LC-MS system 100 or mass spectrometer 104 (e.g., controller 106 or controller 206). Alternatively, training module 802 may be implemented by a computing system (e.g., a personal computer or a remote server) separate from but communicatively coupled with a controller of LC-MS system 100 or mass spectrometer 104.

In some embodiments, machine learning model 804 is implemented using one or more supervised and/or unsupervised learning algorithms. For example, machine learning model 804 may be implemented by a neural network (e.g., a convolutional neural network (CNN)) having an input layer, one or more hidden layers, and an output layer. In some examples, machine learning model 804 is implemented by an autoencoder neural network, such as a denoising autoencoder neural network. Generally, a denoising autoencoder neural network is trained on pairs of noisy and clean data to recognize important features of a family of signals and eliminate noise. However, the denoising autoencoder neural network may also be applied to perform the task of upsampling mass chromatogram data, as described above. To this end, the denoising autoencoder takes as an input vector a segment of an elution profile for a selected m/z. The input vector includes a sequence of acquisition points of the elution profile for the selected m/z (e.g., 8, 16, 24, 32, 48, 64, 128, etc.). The input vector is passed through an encoder including successive iterations each including a convolutional layer followed by a rectified linear unit activation and max pooling operation. The decoder includes transpose convolutional operations that reconstruct a “denoised” output with the same size as the input.

Training data 806 includes a set of training examples 810 (e.g., training examples 810-1 through 810-N). Each training example 810 includes a first mass chromatogram dataset 812 and a second mass chromatogram dataset 814. First mass chromatogram dataset 812 has a first sampling rate (e.g., a high sampling rate) and second mass chromatogram dataset 814 has a second sampling rate that is less than the first sampling rate (e.g., a low sampling rate). First mass chromatogram dataset 812 and second mass chromatogram dataset 814 correspond to “clean” data and “noisy” data, respectively, that are generally used to train a denoising autoencoder.

Training data 806 may be generated in any suitable way. In some examples, training data 806 is generated based on a series of mass spectra acquired over time as analytes included in a sample elute from a separation system. The series of mass spectra may be acquired in any suitable way, such as by performing a single-stage MS analysis (e.g., full scan MS or SIM analysis), a multi-stage wide or full scan MS2 or MSn analysis, a targeted acquisition method (e.g., an SRM/MRM, PRM, or other targeted analysis), or a DIA analysis of the sample, as described above with regard to method 500. In some examples, the series of mass spectra are acquired with a sampling rate that is equal to or greater than a sampling rate requirement for the experiment. The sampling rate requirement may be determined, for example, based on user input and/or based on experiment conditions (e.g., a list of target analytes, a description or identification of the particular analytical method performed for the experiment, etc.).

In an MS, MS2, or MSn wide or full scan analysis, each training example 810 may correspond to a distinct selected m/z and is based on all or a portion of the recorded intensity signal as a function of elution time for the ions of the selected m/z. In some embodiments, each training example 810 corresponds to a distinct extracted ion chromatogram (XIC).

In a targeted analysis, each training example 810 may correspond to a distinct transition (precursor ion/product ion pair) and is based on all or a portion of the recorded intensity signal as a function of elution time for the product ion of the transition. The selected m/z is the m/z of the product ion of the transition. Each analyte included in the sample may have multiple transitions with one or more precursor ions, and thus each analyte may have multiple transitions that correspond to multiple training examples 810. Generating a distinct training example 810 for each distinct transition of an analyte increases the quantity and variety and, hence, quality of training data 806. In a DIA method, each training example 810 corresponds to a distinct product ion. The selected m/z is the m/z of the product ion.

First mass chromatogram dataset 812 includes a sequence of acquisition points over a time period that includes an elution peak of the elution profile formed by the sequence of acquisition points. First mass chromatogram dataset 812 has a first sampling rate. In some examples, the first sampling rate is a high sampling rate (e.g., equal to or greater than a sampling rate requirement for the analysis). In some examples, such as when the series of mass spectra is acquired using a sampling rate that is different than the first sampling rate or when the sampling period of the original series of mass spectra is not uniform (e.g., due to instrument or experiment variations), first mass chromatogram dataset 812 is generated by obtaining and adjusting a subset of the original acquisition points of the series of mass spectra to a uniform sampling period (e.g., 0.5 seconds), such as by interpolation (e.g. linear interpolation, non-linear interpolation, spline fitting, sinc interpolation), so that first mass chromatogram dataset 812 has the first sampling rate. Such adjustment to a uniform sampling period simplifies training of machine learning model 804. To illustrate, a subset of acquisition points extracted from the series of mass spectra may have a sampling period ranging between 1.7 and 1.9 seconds. These original acquisition points may be adjusted by interpolation to generate a sequence of acquisition points having a uniform 0.5 second sampling period.

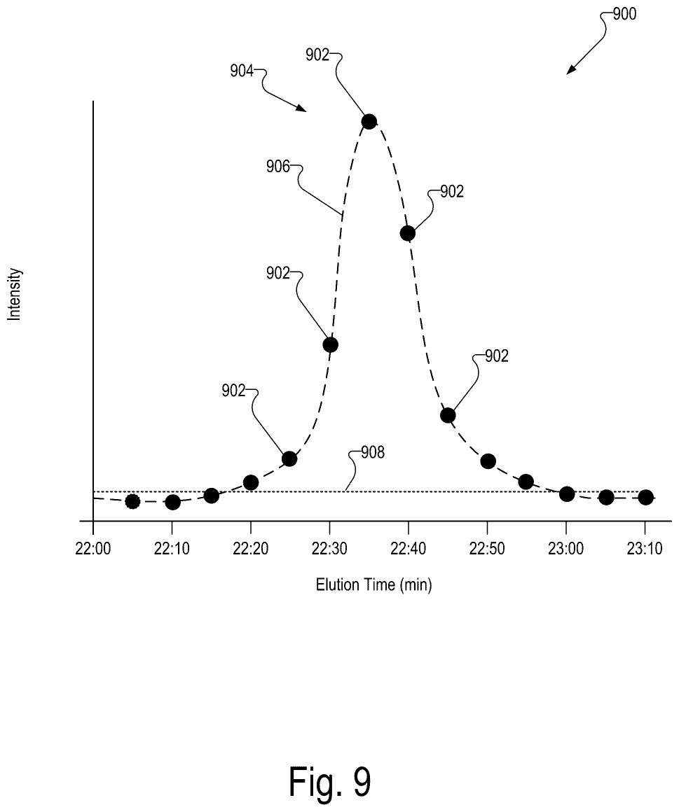

FIG. 9 shows an illustrative representation 900 of first mass chromatogram dataset 812 of training example 810-1. As shown, first mass chromatogram dataset 812 includes fourteen acquisition points 902. Each acquisition point 902 represents intensity as a function of elution time for a selected m/z. Acquisition points 902 have a uniform sampling period of five seconds. Acquisition points 902 together form an elution profile 904 having an elution peak 906 comprising acquisition points 902 above a threshold intensity level 908. As shown, first mass chromatogram dataset 812 has a first sampling rate of eight acquisition points across elution peak 906. If the sampling rate requirement for the experiment is six acquisition points per peak, the first sampling rate of first mass chromatogram dataset 812 is a high sampling rate (e.g., greater than the sampling rate requirement for the experiment).

Referring again to FIG. 8, second mass chromatogram dataset 814 includes a sequence of acquisition points over the same time period as first mass chromatogram dataset 812. Second mass chromatogram dataset 814 has a second sampling rate that is lower than the first sampling rate. In some examples, the second sampling rate is a low sampling rate (e.g., a sampling rate that is less than a sampling rate requirement for the experiment).

Second mass chromatogram dataset 814 may be generated in any suitable way. In some examples, second mass chromatogram dataset 814 is generated based on first mass chromatogram dataset 812, such as by downsampling first mass chromatogram dataset 812. First mass chromatogram dataset 812 may be downsampled to generate second mass chromatogram dataset 814 in any suitable way. In some examples, first mass chromatogram dataset 812 is downsampled by retaining every kth acquisition point of the sequence of acquisition points of first mass chromatogram dataset 812, where k is an integer greater than or equal to two (e.g., between two and eight, inclusive). Other downsampling methods may be used. For example, every kth and (k+1)th acquisition point in first mass chromatogram dataset 812 may be removed and replaced by a single acquisition point estimated by interpolation (e.g., by interpolation between the kth and (k+1)th acquisition points or by interpolation between the (k−1)th and (k+2)th acquisition point). In some examples, downsampling of first mass chromatogram dataset 812 is limited by the baseline width of the elution peak to ensure that a minimum threshold number of acquisition points remain across the peak (e.g., 2, 3, 4, etc.). In the downsampling examples described above, acquisition points that are not retained may be assigned an intensity value of zero so that second mass chromatogram dataset 814 has the same number of acquisition points as first mass chromatogram dataset 812. Alternatively, the intensity values of acquisition points that are not retained are estimated by interpolation.

In some examples, generating second mass chromatogram dataset 814 also includes normalizing the sequence of acquisition points to a reference intensity value. In some examples, the reference intensity value is a maximum intensity value of second mass chromatogram dataset 814. However, any other normalization scheme may be used, and the reference intensity value may be any other suitable reference value, such as a known running maximum or average intensity value of the elution profile, a global maximum intensity value of the series of mass spectra, a recent maximum or average intensity value, etc. In some examples, the normalization scheme may include a baseline slope and/or a baseline level correction. For example, the normalized intensity value may be determined as the ratio of the difference between the last intensity value and a baseline intensity value to the difference between the maximum intensity value and the baseline intensity value.

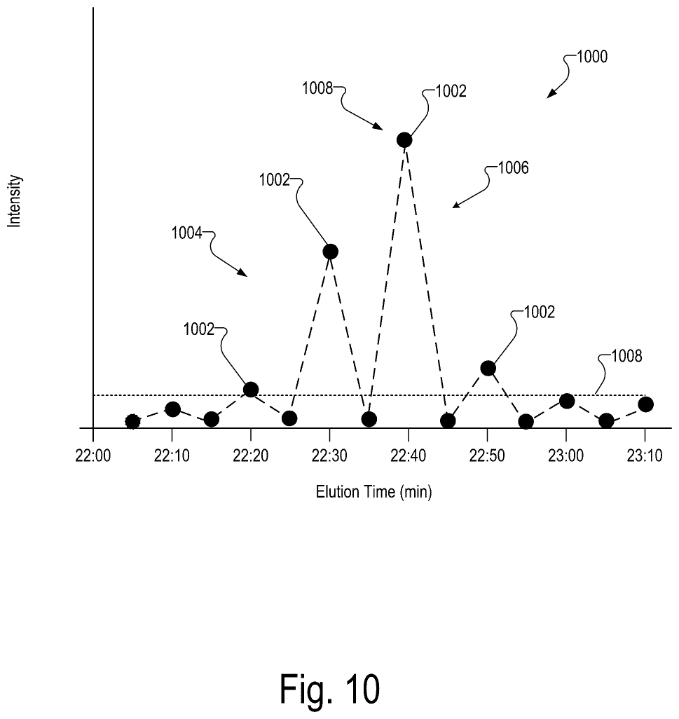

FIG. 10 shows an illustrative representation 1000 of second mass chromatogram dataset 814. As shown, second mass chromatogram dataset 814 includes 14 acquisition points 1002. Each acquisition point 1002 represents intensity as a function of elution time for the selected m/z of FIG. 9. Second mass chromatogram dataset 814 is obtained by retaining every second acquisition point of first mass chromatogram dataset 812 (e.g., k=2) and assigning non-retained acquisition points a value of zero, although non-retained acquisition points may instead be estimated by interpolation. Acquisition points 1002 together form a downsampled elution profile 1004 of the selected m/z. Elution profile 1004 includes an elution peak 1006 having an apex 1008 at which intensity is at a maximum intensity value. In some examples, acquisition points 902 and 1002 are normalized relative to apex 1008. As shown in FIG. 10, second mass chromatogram dataset 814 has a second sampling rate of 4 acquisition points across elution peak 1006. Downsampling of first mass chromatogram dataset 812 has been performed so that the second sampling rate of second mass chromatogram dataset 814 is less than the sampling rate requirement for the experiment of six acquisitions per elution peak.

Referring again to FIG. 8, training data 806 may be augmented in various different ways to generate a more robust set of training data 806 by increasing the amount of training data 806 and/or increasing the variety of training data 806. A more robust set of training data 806 improves training of machine learning model 804. Examples of augmenting training data 806 will now be described.

In some examples, training data 806 is augmented by varying the downsampling phase across training examples 810. The downsampling phase refers to the position, along the elution time axis of first mass chromatogram dataset 812, of the acquisition points that are downsampled. In the example of FIG. 9, second mass chromatogram dataset 814 is obtained by retaining every second acquisition point of first mass chromatogram dataset 812 (e.g., k=4), beginning with the second acquisition point 902. With a different downsampling phase, downsampling would begin with the first acquisition point 902. In some examples, the downsampling phase for each training example 810 (e.g., for generating each second mass chromatogram dataset 814) is selected randomly. In alternative examples, the downsampling phase for each training example 810 is selected according to a predetermined pattern or algorithm.

Additionally or alternatively to varying the downsampling phase, a sub-region of acquisition points may be cropped from each training example 810 (e.g., from each first mass chromatogram dataset 812 and, hence, from each second mass chromatogram dataset 814) to ensure that elution peaks of have varying positions, along the time axis, across different training examples 810. The cropped sub-region may be any suitable size (e.g., 4 acquisition points, 10 seconds, etc.). In some examples, the position of the cropped sub-region along the time axis is selected randomly for each training example 810, provided that elution peak regions are not cropped. In alternative examples, the cropped sub-region for each training example 810 is selected according to a predetermined pattern or algorithm.

Additionally or alternatively, training data 806 may be augmented by using generative adversarial networks and/or adding noise with certain properties, such as Gaussian or Poisson properties, to the second mass chromatogram dataset 814.

As shown in FIG. 8, second mass chromatogram dataset 814 of training example 810-1 is provided as an input vector to machine learning model 804, which is trained to upsample mass chromatogram data and output a third mass chromatogram dataset 816 having the first sampling rate. Third mass chromatogram dataset 816 represents an estimated sequence of acquisition points over the same time period as second mass chromatogram dataset 814. First mass chromatogram dataset 812 is the known desired output from machine learning model 804 and may be used for evaluating the output of machine learning model 804. For example, first mass chromatogram dataset 812 may be provided as input to evaluation unit 808, which is configured to determine (e.g., compute), based on third mass chromatogram dataset 816 output from machine learning model 804 and first mass chromatogram dataset 812, an evaluation value that is provided to machine learning model 804. Based on the evaluation value, training module 802 may adjust one or more model parameters of machine learning model 804. Machine learning model 804 may then be trained on a next training example (e.g., training example 810-2), and training may proceed through all training examples 810. Training on training examples 810 may be repeated.

In some examples, training data 806 is split into two subsets of data, such that a first subset of training data 806 is used for training machine learning model 804 and a second subset of training data is used to score machine learning model 804. For example, training data 806 may be split so that a first percentage (e.g., 75%) of training examples 810 are used as the training set for training machine learning model 804 and a second percentage (e.g., 25%) of the training examples 810 are used as the scoring set to generate an accuracy score for machine learning model 804.

In some examples, training module 802 may determine a lowest possible sampling rate that maintains a threshold level of fidelity of the estimated high sampling rate dataset output by machine learning model (e.g., third mass chromatogram dataset 816) to the original high sampling rate data (first mass chromatogram dataset 812). For example, training of machine learning model 804 may be performed on different sets of training data 806, wherein each set of training data 806 is generated using a different sampling rate for each second mass chromatogram dataset 814. For instance, a first set of training data 806 may be configured for a first low sampling rate (e.g., a sampling period of one second), a second set of training data 806 may be configured for a second low sampling rate (e.g., a sampling period of two seconds), and a third set of training data 806 may be configured for a third low sampling rate (e.g., a sampling period of three seconds). Training module 802 may evaluate the output of machine learning model 804 for each set of training data 806 and identify the lowest possible sampling rate based on the evaluation value for each set of training data 806. This lowest possible sampling rate may then be used during an experimental analysis to acquire a series of mass spectra.

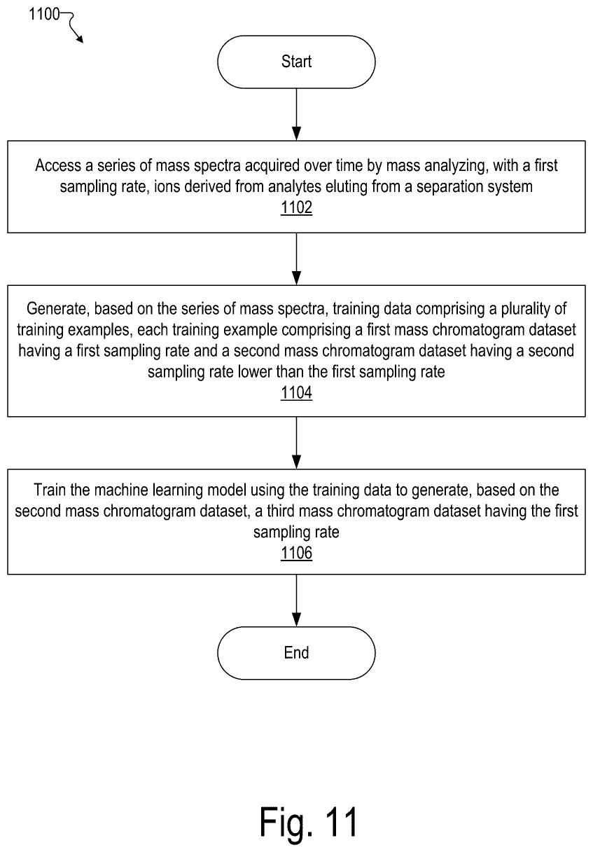

FIG. 11 shows an illustrative method 1100 that may be performed to train machine learning model 804 to upsample mass chromatogram data. While FIG. 11 shows illustrative operations according to one embodiment, other embodiments may omit, add to, reorder, and/or modify one or more operations of the method 1100 depicted in FIG. 11. Each operation of method 1100 depicted in FIG. 11 may be performed in any manner described herein.

At operation 1102, training module 802 accesses a series of mass spectra acquired over time by mass analyzing, with a first sampling rate, ions derived from analytes eluting from a separation system. In some examples, the first sampling rate is a high sampling rate.

At operation 1104, training module 802 generates, based on the series of mass spectra, training data 806 including a plurality of training examples 810. Each training example 810 includes a first mass chromatogram dataset 812 and a second mass chromatogram dataset 814. First mass chromatogram dataset 812 includes a sequence of acquisition points surrounding an elution peak for the selected m/z and has a first sampling rate (e.g., a high sampling rate). First mass chromatogram dataset 812 may be generated in any way described herein. In some examples, generating first mass chromatogram dataset 812 includes adjusting a subset of acquisition points of the series of mass spectra corresponding to the selected m/z to a uniform sampling period. Second mass chromatogram dataset 814 includes a sequence of acquisition points surrounding the elution peak for the selected m/z and has a second sampling rate that is lower than the first sampling rate. In some examples, the second sampling rate is a low sampling rate. Second mass chromatogram dataset 814 may be generated in any way described herein. In some examples, second mass chromatogram dataset 814 is generated 814 by downsampling first mass chromatogram dataset 812, such as by any downsampling method described herein. In some examples, generating second mass chromatogram dataset 814 includes normalizing the acquisition points of second mass chromatogram dataset 814 to a reference intensity value.

At operation 1106, training module 802 uses training data 806 to train machine learning model 804 to output third mass chromatogram dataset 816, which has the first sampling rate (e.g., a high sampling rate). Once trained, machine learning model 804 may be used to upsample mass chromatogram data.

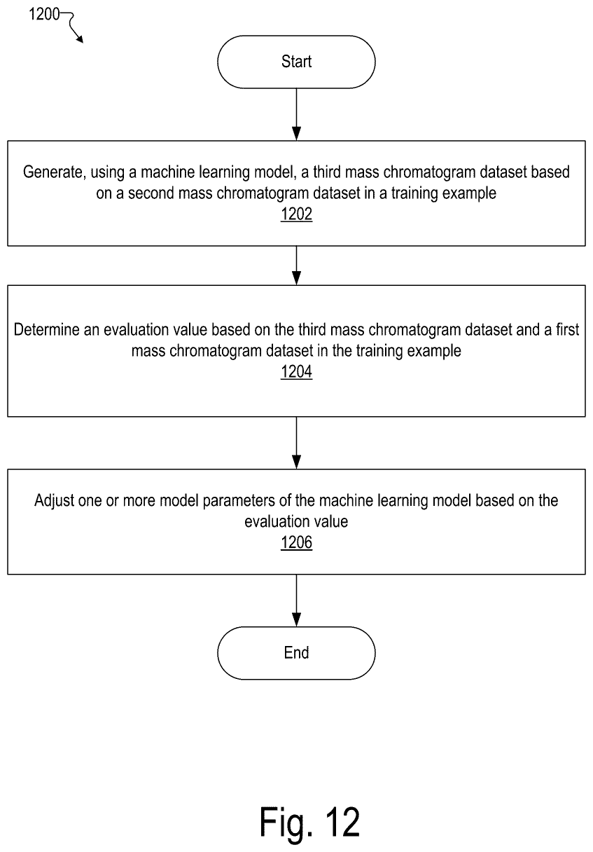

FIG. 12 shows an illustrative method 1200 of training machine learning model 804 with a training example 810 during training stage 800 of FIG. 8. While FIG. 12 shows illustrative operations according to one embodiment, other embodiments may omit, add to, reorder, and/or modify one or more operations of the method 1200. Each operation of method 1200 depicted in FIG. 12 may be performed in any manner described herein.

At operation 1202, training module 802 generates, using machine learning model 804, third mass chromatogram dataset 816 based on second mass chromatogram dataset 814 in training example 810-1.

At operation 1204, training module 802 determines an evaluation value based on first mass chromatogram dataset 812 and third mass chromatogram dataset 816 in training example 810-1. For example, as shown in FIG. 8, training module 802 may input third mass chromatogram dataset 816 generated by machine learning model 804 and first mass chromatogram dataset 812 in training example 810-1 into evaluation unit 808. Evaluation unit 808 may determine the evaluation value based on first mass chromatogram dataset 812 and third mass chromatogram dataset 816. The evaluation value is any value representing a comparison of first mass chromatogram dataset 812 and third mass chromatogram dataset 816, such as a mean squared difference. Other implementations for determining the evaluation value are also possible and contemplated.

At operation 1206, training module 802 adjusts one or more model parameters of machine learning model 804 based on the determined evaluation value. For example, as shown in FIG. 8, training module 802 may back-propagate the evaluation value determined by evaluation unit 808 to machine learning model 804 and adjust the model parameters of machine learning model 804 (e.g., weight values assigned to various data elements in training examples 810) based on the evaluation value.

In some embodiments, training module 802 may determine whether the model parameters of machine learning model 804 have been sufficiently adjusted. For example, training module 802 may determine that machine learning model 804 has been subjected to a predetermined number of training cycles and therefore has been trained with a predetermined number of training examples. Additionally or alternatively, training module 802 may determine that the evaluation value satisfies a predetermined evaluation value threshold for a threshold number of training cycles, and thus determine that the model parameters of machine learning model 804 have been sufficiently adjusted. Additionally or alternatively, training module 802 may determine that the evaluation value remains substantially unchanged for a predetermined number of training cycles (e.g., a difference between the evaluation values computed in sequential training cycles satisfies a difference threshold), and thus determine that the model parameters of machine learning model 804 have been sufficiently adjusted.

In some embodiments, responsive to determining that the model parameters of machine learning model 804 have been sufficiently adjusted, training module 802 may determine that the training stage of machine learning model 804 is completed and select the current values of the model parameters to be values of the model parameters in trained machine learning model 804. Trained machine learning model 804 may implement an upsampling model configured to upsample mass chromatogram data, including mass chromatogram data having a low sampling rate.

In some examples, machine learning model 804 is trained based on training data 806 acquired during multiple different experiments performed under different sets of experiment conditions. As a result, trained machine learning model 804 may be used across a wide range of experiment conditions. Experiment conditions include, without limitation, one or more of a flow rate of the separation system (e.g., nanoflow, microflow, high flow), a gradient of the chromatography column, a list of target analytes, a type of chromatography performed, or a type of stationary phase and/or mobile phase of the chromatography column. Machine learning model 804 may be trained for use under a wide range of experiment conditions in any suitable way.

In some examples, training data 806 includes a plurality of subsets of training data. Each subset of training data is acquired based on a distinct set of experiment conditions. Training module 802 may train machine learning model 804 on each individual subset of training data serially in a plurality of training stages. For example, training module 802 may train machine learning model 804 on a first subset of training data 806 in a first training stage. Upon completion of training with the first subset, training module 802 may train machine learning model 804 on a second subset of training data 806 in a second training stage. Upon completion of training with the second subset, training module 802 may train machine learning model 804 on a third subset of training data 806 in a third training stage, and so forth.

Alternatively, data from multiple different subsets of training data may be mixed so that machine learning model 804 is trained on the different subsets of training data in one training stage. For example, training examples from the various different subsets of training data may be mixed (e.g., randomly) to form training data 806. In some embodiments, training examples 810 associated with the same elution peak for the same selected m/z may be grouped together so that all training examples 810 associated with the elution peak are trained in sequence before machine learning model 804 is trained using training examples 810 from a different group.

In some examples, each training example 810 may further include, in addition to first mass chromatogram dataset 812 and second mass chromatogram dataset 814, data representative of one or more experiment conditions. The data representative of one or more experiment conditions may be automatically accessed or obtained by training module 802 from the LC-MS system (e.g., from controller 106 or controller 206), or may be provided manually by a user.

In alternative examples, machine learning model 804 is trained based on training data 806 configured for a specific application, such as a selected m/z, specific experiment conditions, a specific sample type, etc. In such examples, machine learning model 804 may be trained after acquiring data for an initial priming experiment, and machine learning model 804 may be used thereafter only for subsequent iterations of that specific experiment.

In some examples, machine learning model 804 may be refined or further trained in real time during an analytical experiment. In some embodiments, training module 802 may continue to collect training examples 810 and train machine learning model 804 with the collected training examples 810 over time during an experiment. For example, when training module 802 collects one or more additional training examples from one or more data sources, training module 802 may update the plurality of training examples to include both existing training examples and the additional training examples, and train machine learning model 804 with the updated plurality of training examples according to the training process described herein. Additionally or alternatively, training module 802 may periodically collect additional training examples from one or more other data sources, update the plurality of training examples to include both existing training examples and the additional training examples, and train machine learning model 804 with the updated plurality of training examples at predetermined intervals.

Trained machine learning model 804 may also be scored and/or updated (e.g., re-trained) in real-time during an analytical experiment based on data acquired during the analytical experiment (e.g., based on analytical acquisitions or scans). At various times throughout an analytical experiment, system 400 may perform an assessment to assess the performance of trained machine learning model 804 using analytical data already acquired up to that point. Assessments may be performed at any suitable time, such as periodically (e.g., every nth acquisition), randomly, or in response to a trigger event (e.g., detection of coalescence or peak broadening exceeding a threshold amount). Each assessment may assess the quality of trained machine learning model 804. If system 400 determines during an assessment that an error condition is satisfied, system 400 may retrain and/or update machine learning model 804 using the acquired experimental data.

In some examples, machine learning model 804 may be trained using a chromatogram library. In this example, a sample may be characterized using multiple different DIA experiments that use a smaller-than-normal isolation (e.g., between one and four m/z), with each experiment covering a different subset m/z range (e.g., 200 m/z) of a wide precursor m/z range (e.g., 400 m/z to 1000 m/z). The compounds to be analyzed in subsequent experiments are identified from the MS2 data produced by these combined experiments, including their elution times and characteristic MS2 spectra. These data, collectively termed a “chromatogram library,” enable processing of subsequent experiment, which may take the form of DIA experiments with wider isolation widths (e.g., 20 m/z), or assays with targeted MS2 acquisitions, such as SRM/MRM or PRM experiments. Because the acquisition of the chromatogram library is only performed once before a large group of samples is run, throughput is not of the essence during its acquisition, and the series of MS2 spectra may be acquired with high sampling rates.

The chromatogram library data may be a source of data for training machine learning model 804 and determining a lowest feasible sampling rate that is able to reconstruct high sampling rate data for the largest number of analytes. For example, first mass chromatogram dataset 812 and second mass chromatogram dataset 814 may be generated from the chromatogram library data. Furthermore, the shape of the elution profile for each analyte may be different, as indicated by the chromatogram library data. Accordingly, system 400 may determine a customized lowest feasible sampling rate for each analyte and operate the mass spectrometer during a targeted experiment in such a way that analytes are sampled at their custom sampling rate. Thus, some analytes may be sampled at higher rates while other analytes are sampled at lower rates.

If machine learning model 804 is updated during an analytical experiment, the updated machine learning model 804 may be used as the default machine learning model for the next experiment. In this way, machine learning model 804 can be re-trained and updated on the fly without consuming additional time for re-training and updating. The real-time assessment and updating process need not require input from the user, thereby improving convenience for the user.

Various modifications may be made to the methods, apparatuses, and systems described herein. In some examples, a separation device (e.g., a liquid chromatograph, a gas chromatograph, a capillary electrophoresis device, etc.) and/or a mass spectrometer (e.g., mass spectrometer 104) may include or may be coupled with an ion mobility analyzer, and data acquired by the ion mobility analyzer may be used to train an upsampling model (e.g., machine learning model 804) and generate an estimated high sampling rate dataset in a manner similar to the methods described above for data acquired by the mass spectrometer.

In some examples, system 400 may be configured to request user input to manage or adjust settings of the upsampling technique. For example, system 400 may obtain, from a user, method settings, a list of target analytes, a selected m/z, a sampling rate requirement, and/or any other initial or default values of parameters associated with the analytical method and/or the upsampling model. System 400 may also be configured to notify the user of certain changes, such as when the sampling rate requirement changes, when the average peak width of eluting analytes changes, or when an assessment indicates model parameters should be adjusted.

In certain embodiments, one or more of the systems, components, and/or processes described herein may be implemented and/or performed by one or more appropriately configured computing devices. To this end, one or more of the systems and/or components described above may include or be implemented by any computer hardware and/or computer-implemented instructions (e.g., software) embodied on at least one non-transitory computer-readable medium configured to perform one or more of the processes described herein. In particular, system components may be implemented on one physical computing device or may be implemented on more than one physical computing device. Accordingly, system components may include any number of computing devices, and may employ any of a number of computer operating systems.

In certain embodiments, one or more of the processes described herein may be implemented at least in part as instructions embodied in a non-transitory computer-readable medium and executable by one or more computing devices. In general, a processor (e.g., a microprocessor) receives instructions, from a non-transitory computer-readable medium, (e.g., a memory, etc.), and executes those instructions, thereby performing one or more processes, including one or more of the processes described herein. Such instructions may be stored and/or transmitted using any of a variety of known computer-readable media.

A computer-readable medium (also referred to as a processor-readable medium) includes any non-transitory medium that participates in providing data (e.g., instructions) that may be read by a computer (e.g., by a processor of a computer). Such a medium may take many forms, including, but not limited to, non-volatile media, and/or volatile media. Non-volatile media may include, for example, optical or magnetic disks and other persistent memory. Volatile media may include, for example, dynamic random access memory (“DRAM”), which typically constitutes a main memory. Common forms of computer-readable media include, for example, a disk, hard disk, magnetic tape, any other magnetic medium, a compact disc read-only memory (“CD-ROM”), a digital video disc (“DVD”), any other optical medium, random access memory (“RAM”), programmable read-only memory (“PROM”), electrically erasable programmable read-only memory (“EPROM”), FLASH-EEPROM, any other memory chip or cartridge, or any other tangible medium from which a computer can read.

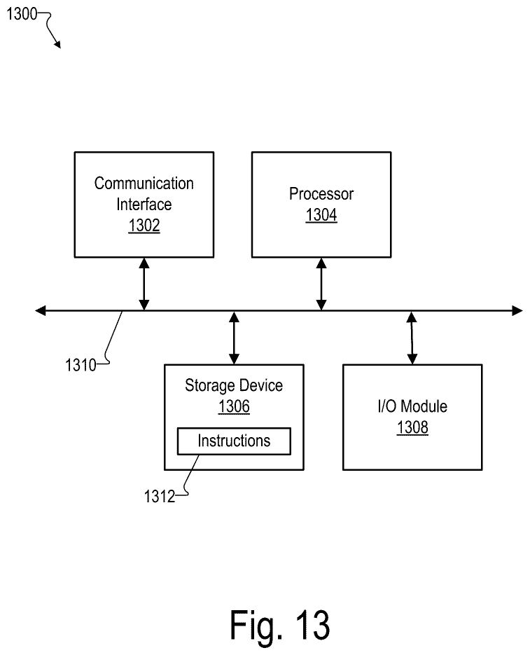

FIG. 13 shows an illustrative computing device 1300 that may be specifically configured to perform one or more of the processes described herein. As shown in FIG. 13, computing device 1300 may include a communication interface 1302, a processor 1304, a storage device 1306, and an input/output (“I/O”) module 1308 communicatively connected one to another via a communication infrastructure 1310. While an illustrative computing device 1300 is shown in FIG. 13, the components illustrated in FIG. 13 are not intended to be limiting. Additional or alternative components may be used in other embodiments. Components of computing device 1300 shown in FIG. 13 will now be described in additional detail.

Communication interface 1302 may be configured to communicate with one or more computing devices. Examples of communication interface 1302 include, without limitation, a wired network interface (such as a network interface card), a wireless network interface (such as a wireless network interface card), a modem, an audio/video connection, and any other suitable interface.

Processor 1304 generally represents any type or form of processing unit capable of processing data and/or interpreting, executing, and/or directing execution of one or more of the instructions, processes, and/or operations described herein. Processor 1304 may perform operations by executing computer-executable instructions 1312 (e.g., an application, software, code, and/or other executable data instance) stored in storage device 1306.

Storage device 1306 may include one or more data storage media, devices, or configurations and may employ any type, form, and combination of data storage media and/or device. For example, storage device 1306 may include, but is not limited to, any combination of the non-volatile media and/or volatile media described herein. Electronic data, including data described herein, may be temporarily and/or permanently stored in storage device 1306. For example, data representative of computer-executable instructions 1312 configured to direct processor 1304 to perform any of the operations described herein may be stored within storage device 1306. In some examples, data may be arranged in one or more databases residing within storage device 1306.

I/O module 1308 may include one or more I/O modules configured to receive user input and provide user output. One or more I/O modules may be used to receive input for a single virtual experience. I/O module 1308 may include any hardware, firmware, software, or combination thereof supportive of input and output capabilities. For example, I/O module 1308 may include hardware and/or software for capturing user input, including, but not limited to, a keyboard or keypad, a touchscreen component (e.g., touchscreen display), a receiver (e.g., an RF or infrared receiver), motion sensors, and/or one or more input buttons.

I/O module 1308 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O module 1308 is configured to provide graphical data to a display for presentation to a user. The graphical data may be representative of one or more graphical user interfaces and/or any other graphical content as may serve a particular implementation.

In some examples, any of the systems, computing devices, and/or other components described herein may be implemented by computing device 1300. For example, storage facility 402 may be implemented by storage device 1306, and processing facility 404 may be implemented by processor 1304.

It will be recognized by those of ordinary skill in the art that while, in the preceding description, various illustrative embodiments have been described with reference to the accompanying drawings. It will, however, be evident that various modifications and changes may be made thereto, and additional embodiments may be implemented, without departing from the scope of the invention as set forth in the claims that follow. For example, certain features of one embodiment described herein may be combined with or substituted for features of another embodiment described herein. The description and drawings are accordingly to be regarded in an illustrative rather than a restrictive sense.

What is claimed is:

1. A non-transitory computer-readable medium storing instructions that, when executed, direct at least one processor of a computing device for mass spectrometry to:
obtain, based on a series of mass spectra acquired over time with a first sampling rate as analytes elute from a separation system during an experiment, a first mass chromatogram dataset representing a detected intensity of ions derived from the analytes and having a selected m/z as a function of time over a time period; and
generate, based on the first mass chromatogram dataset and an upsampling model trained to upsample mass chromatogram data, a second mass chromatogram dataset representing an estimated intensity of the ions as a function of time over the time period, the second mass chromatogram dataset having a second sampling rate that is greater than the first sampling rate.

2. The computer-readable medium of claim 1, wherein obtaining the first mass chromatogram dataset comprises adjusting a subset of acquisition points for the selected m/z obtained from the series of mass spectra to a uniform sampling period.

3. The computer-readable medium of claim 1, wherein the upsampling model comprises a trained autoencoder-decoder network.

4. The computer-readable medium of claim 1, wherein:
the first sampling rate is less than a sampling rate requirement for the experiment; and
the second sampling rate is equal to or greater than the sampling rate requirement for the experiment.

5. The computer-readable medium of claim 4, wherein the instructions, when executed, further direct the at least one processor to:
determine the sampling rate requirement; and
set the first sampling rate based on the sampling rate requirement.

6. The computer-readable medium of claim 5, wherein the first sampling rate is set as a percentage of the sampling rate requirement.

7. The computer-readable medium of claim 4, wherein the sampling rate requirement is at least six acquisitions per elution peak.

8. The computer-readable medium of claim 1, wherein the first sampling rate is between two and five acquisitions per peak.

9. The computer-readable medium of claim 1, wherein the second sampling rate is at least twice the first sampling rate.

10. The computer-readable medium of claim 1, wherein the series of mass spectra comprise MS2 spectra acquired by performing a targeted analysis or a data independent acquisition (DIA) analysis of a sample comprising the analytes.

11. A non-transitory computer-readable medium storing instructions that, when executed, direct at least one processor of a computing device for mass spectrometry to:
obtain a series of mass spectra acquired over time during an experiment by mass analyzing, with a first sampling rate, ions derived from analytes eluting from a separation system;
generate, based on the series of mass spectra, training data comprising a set of training examples, each training example comprising a first mass chromatogram dataset for a selected m/z and a second mass chromatogram dataset for the selected m/z, wherein:
the first mass chromatogram dataset includes a sequence of acquisition points over a time period and has a first sampling rate, and
the second mass chromatogram dataset comprises a sequence of acquisition points over the time period and has a second sampling rate that is lower than the first sampling rate; and
train, using the training data, a machine learning model to generate, based on the second mass chromatogram dataset, a third mass chromatogram dataset having the first sampling rate.

12. The computer-readable medium of claim 11, wherein generating the training data comprises generating the first mass chromatogram dataset by adjusting a subset of acquisition points of the series of mass spectra for the selected m/z to a uniform sampling period.

13. The computer-readable medium of claim 11, wherein generating the second mass chromatogram dataset comprises normalizing the sequence of acquisition points of the second mass chromatogram dataset to a reference intensity value.

14. The computer-readable medium of claim 11, wherein generating the training data comprises generating the second mass chromatogram dataset by downsampling the first mass chromatogram dataset.

15. The computer-readable medium of claim 14, wherein downsampling the first mass chromatogram dataset comprises retaining every kth acquisition point included in the first mass chromatogram dataset, where k is an integer between 2 and 8, inclusive.

16. The computer-readable medium of claim 15, wherein downsampling the first mass chromatogram dataset further comprises estimating, by interpolation, an intensity value of acquisition points that are not retained.

17. The computer-readable medium of claim 15, wherein downsampling the first mass chromatogram dataset further comprises assigning acquisition points that are not retained an intensity value of zero.

18. The computer-readable medium of claim 15, wherein generating the second mass chromatogram dataset comprises randomly selecting a downsampling phase.

19. The computer-readable medium of claim 11, wherein the machine learning model comprises a convolutional autoencoder-decoder neural network.

20. The computer-readable medium of claim 11, wherein each training example of the set of training examples corresponds to a distinct transition.

21. The computer-readable medium of claim 11, wherein:
the first sampling rate is equal to or greater than a sampling rate requirement for the experiment; and
the second sampling rate is less than the sampling rate requirement for the experiment.

22. The computer-readable medium of claim 21, wherein the instructions, when executed, further direct the at least one processor to:
determine the sampling rate requirement; and
set the second sampling rate based on the sampling rate requirement.

23. The computer-readable medium of claim 22, wherein the second sampling rate is set as a percentage of the sampling rate requirement.

24. The computer-readable medium of claim 21, wherein the sampling rate requirement is at least six acquisitions per elution peak.

25. The computer-readable medium of claim 11, wherein the second sampling rate is between two and five acquisitions per peak.

26. The computer-readable medium of claim 11, wherein the first sampling rate is at least twice the second sampling rate.

27. The computer-readable medium of claim 11, wherein the series of mass spectra comprise MS2 spectra acquired by performing a targeted analysis or a data independent acquisition (DIA) analysis of a sample comprising the analytes.

28. A system for performing mass spectrometry, comprising:
a memory storing instructions; and
a processor communicatively coupled to the memory and configured to execute the instructions to:
obtain, based on a series of mass spectra acquired over time with a first sampling rate as analytes elute from a separation system during an experiment, a first mass chromatogram dataset representing a detected intensity of ions derived from the analytes and having a selected m/z as a function of time over a time period; and
generate, based on the first mass chromatogram dataset and an upsampling model trained to upsample mass chromatogram data, a second mass chromatogram dataset representing an estimated intensity of the ions as a function of time over the time period, the second mass chromatogram dataset having a second sampling rate that is greater than the first sampling rate.

29. The system of claim 28, wherein the upsampling model comprises a trained autoencoder-decoder network.

30. The system of claim 28, wherein:
the first sampling rate is less than a sampling rate requirement for the experiment; and
the second sampling rate is equal to or greater than the sampling rate requirement for the experiment.

31. The system of claim 30, wherein the processor is further configured to execute the instructions to:
determine the sampling rate requirement; and
set the first sampling rate based on the sampling rate requirement.

32. The system of claim 31, wherein the first sampling rate is set as a percentage of the sampling rate requirement.

33. The system of claim 30, wherein the sampling rate requirement is at least six acquisitions per elution peak.
